(19) United States
(12) Patent Application Publication
(10) Pub. No.: US 2013/0060585 A1
(43) Pub. Date: Mar. 7, 2013

(54) Processing Data Using Rules Based Engine

(71) Applicants: Terry Wayne Hornbaker, Holladay, UT (US); Raelynn A. Sink, Lakeville, MN (US); Richard Joseph Lamprea Montero, Makati City (PH)

(72) Inventors: Terry Wayne Hornbaker, Holladay, UT (US); Raelynn A. Sink, Lakeville, MN (US); Richard Joseph Lamprea Montero, Makati City (PH)

(73) Assignee: ACCENTURE GLOBAL SERVICES LIMITED, Dublin (IE)

(21) Appl. No.: 13/224,587

(22) Filed: Sep. 2, 2011

(51) Int. Cl. G06Q 10/00

(52) U.S. Cl. 705/5

(57) ABSTRACT

Methods, systems, and apparatus, including computer programs encoded on a computer storage medium, for performing actions including receiving booking data for one or more customers, receiving profile data for each of the one or more customers, receiving operational data, processing the booking data, the profile data and the operational data based on one or more unit eligibility rules, each unit eligibility rule of the one or more unit eligibility rules including one or more conditions and one or more actions associated with the one or more conditions, generating an eligible unit group index based in the processing, and providing the eligible unit group index as input to a unit selection engine.

### TECHNICAL FIELD

The application relates to a computer-implemented method, a computer system and a computer storage medium for processing data and generating an index.

### BACKGROUND

Certain online reservation systems are used to make travel reservations. For example, online reservation systems can receive a destination and date for travel from a user. The received destination and date of travel can be used as criteria to perform a search to determine whether a travel accommodation (e.g., a seat) on a travel conveyance (e.g., an aircraft) is available. The search may locate one or more travel accommodations that correspond to the received date and destination details.

### SUMMARY

Innovative aspects of the subject matter described in this specification may be embodied in methods that include the actions of receiving booking data for one or more customers, receiving profile data for each of the one or more customers, receiving operational data, processing the booking data, the profile data and the operational data based on one or more unit eligibility rules, each unit eligibility rule of the one or more unit eligibility rules including one or more conditions and one or more actions associated with the one or more conditions, generating an eligible unit group index based in the processing, and providing the eligible unit group index as input to a unit selection engine. Other embodiments of these aspects include corresponding systems, apparatus, and computer programs, configured to perform the actions of the methods, encoded on computer storage devices.

These and other embodiments may each optionally include one or more of the following features: the eligible unit group index includes the one or more customers and, for each customer of the one or more customers, a list of one or more unit groups that each customer of the one or more customers is eligible for; the eligible unit group index is generated at a first time and includes the one or more customers and, for at least one customer of the one or more customers, an empty list of unit groups that the at least one customer is eligible for, the empty list indicating that the at least one customer is ineligible for assignment of a unit at the first time, and the eligible unit group index is re-generated at a second time and, for the at least one customer, includes a list of one or more unit groups that the at least one customer is eligible for at the second time; the unit includes one of a seat and a room in a travel conveyance, and the customer includes a passenger on the travel conveyance; the travel conveyance corresponds to a segment of a journey and the operational data corresponds to the segment; the operational data includes an equipment type associated with the travel conveyance and a load factor associated with the segment; the booking data includes one or more of a fare basis, a booking class, a product class, an organization code, a promotional code, a booking channel, a list of special service requests (SSRs) in a passenger name record (PNR), an SSR associated with a booking of a particular passenger, a day of week of travel, a segment departure station, a segment arrival station, a journey departure station, a journey arrival station, a number of days before departure, a number of hours before departure, a number of minutes before departure, a travel date, a travel time of day, and a passenger age at travel; the booking data includes a role corresponding to an agent that is assigning the unit to a customer; the role overrides one or more unit eligibility rules in assigning the unit to a customer; the profile data includes at least one of passenger date of birth data, a program code of at least one passenger, a program level of at least passenger, a list of special service requests (SSRs) in a passenger name record (PNR), and an SSR associated with a particular passenger; the travel conveyance includes one or an airplane, a train, a bus and a ship; generating the eligible unit group index is based on a current date relative to a departure date; generating the eligible unit group index is based on a current time relative to a departure time; actions further include receiving user input, the user input defining the one or more unit eligibility rules; the user input is provided by an agent of an entity that provides the one or more units; actions further include receiving user input, the user input modifying a unit eligibility rule of the one or more unit eligibility rules; the user input is provided by an agent of an entity that provides the one or more units; the eligible unit group index includes the one or more customers and, for each customer of the one or more customers, a list of one or more unit groups that each customer of the one or more customers is eligible for and one or more requirement identifiers, each requirement identifier being associated with each unit group of the one or more unit groups; each requirement identifier includes at least one of a must be identifier, a may be identifier and a may not be identifier; the must be identifier indicates a unit group from which a unit must be assigned to a particular customer; the may be identifier indicates a unit group from which a unit is able to be assigned to a particular customer; and/or the must not be identifier indicates a unit group from which a unit cannot be assigned to a particular customer.

The details of one or more embodiments of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIG. 1 depicts an example system that can execute implementations of the present disclosure.

FIG. 2 depicts example components that can be used to determine travel accommodation group eligibility.

FIG. 3 depicts an example seat map including example travel accommodation groups.

FIG. 4 is a flowchart of an example process that can be executed in accordance with implementations of the present disclosure.

Like reference symbols in the various drawings indicate like elements.

### DETAILED DESCRIPTION

In the following text, a detailed description of examples will be given with reference to the drawings. It should be understood that various modifications to the examples may be made. In particular, elements of one example may be combined and used in other examples to form new examples.

Implementations of the present disclosure are generally directed to determining an eligibility of a customer for one or more unit groups. In an example context, discussed in further detail below, the customer can include a passenger on a travel conveyance, and a unit can include a travel accommodation. In the example context, the one or more unit groups can include one or more seat groups. That is, in some examples, a travel accommodation can include a seat in a travel conveyance. In some examples, a travel accommodation can include a room in a travel conveyance. In some examples, a travel conveyance can include an airplane, a train, a bus and a ship (e.g., a cruise ship). A travel accommodation group is provided as a group of travel accommodations that a passenger is eligible for.

For purposes of illustration, a non-limiting example context is provided herein. The example context is directed to a travel accommodation including a seat on a travel conveyance. Within the example context of a seat on a travel conveyance, a travel accommodation group includes a group of seats on the travel conveyance that the passenger is eligible for. In some examples, seat groups can be identified by respective numbers (e.g., 0-99). An actual seat that is assigned to the passenger can be selected from one or the travel accommodation groups.

Although implementations of the present disclosure are discussed in the example context of seats on a travel conveyance, it is appreciated that the present disclosure is applicable in other contexts. In some examples, a travel accommodation can include a room on a travel conveyance (e.g., a room on a cruise ship). In some examples, a non-travel accommodation can be considered and can include an entertainment accommodation such as a seat in an auditorium, stadium, theater or similar facilities. In some examples, an accommodation can include a room such as a hotel room or a suite within an entertainment facility.

In accordance with implementations of the present disclosure, and as discussed in further detail below, booking data and profile data for a traveler, and operational data for the travel conveyance are received. The booking data, the profile data and the operational data are processed based on a plurality of criteria to identify one or more seat groups that the traveler is eligible for. In some implementations, discussed in further detail below, the traveler is not eligible for any seat group on the travel conveyance (e.g., seating assignments are not currently available). In some implementations, the traveler is eligible for one or more seat groups, and each seat group is associated with one or more seats of the travel conveyance. An index of eligible seat groups is generated. In some examples, the index of eligible seat groups includes the one or more seat groups and a plurality of requirement identifiers, each requirement identifier corresponding to a seat group. In some examples, seat groups can be identified by respective numbers (e.g., 0-99), and the index of eligible seat groups provides a list of seat groups (e.g., seat groups 40, 52, 60 and 80).The index of eligible seat groups can be provided as input to a seat selection engine for selecting a seat for the traveler.

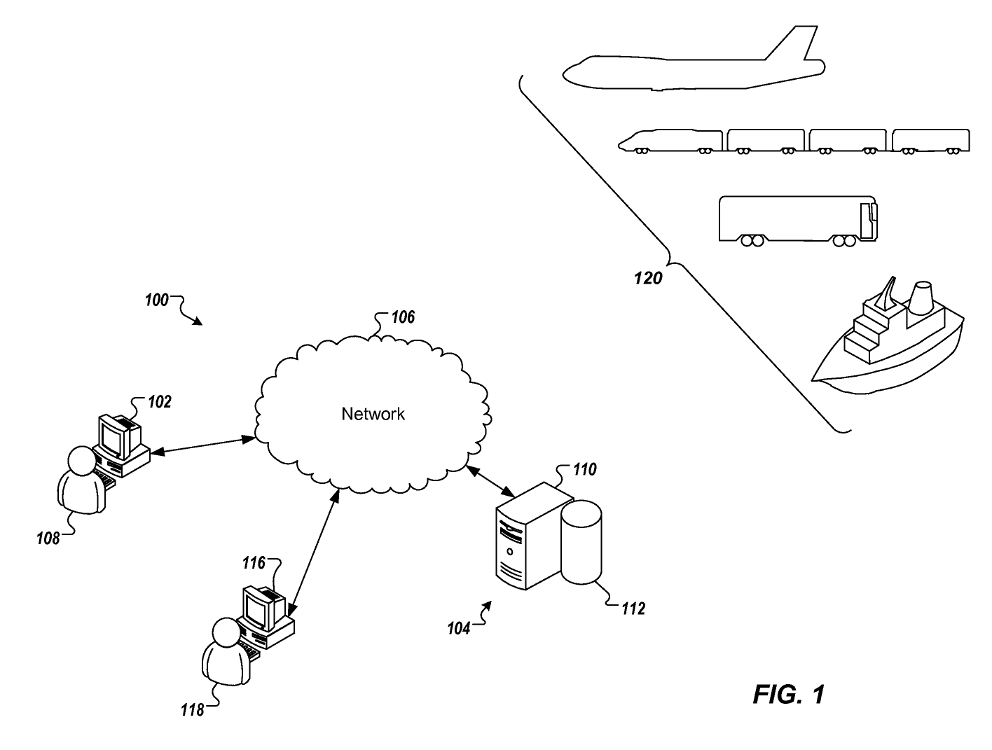

FIG. 1 depicts an example system 100 that can execute implementations of the present disclosure. The example system 100 includes a computing device 102, a computing system 104 and a network 106. The computing device 102 and the computing system 104 can communicate over the network 106. The computing device 102 can be operated by a user 108. The computing system 104 can include one or more computing devices 110 and one or more computer-readable storage devices 112. Another computing device 116 can be provided and can be operated by a user 118.

In some implementations, the computing devices 102, 116 can be computing devices such as laptop or desktop computers, smartphones, personal digital assistants, portable media players, tablet computers, or other appropriate computing devices that can be used to communicate with an electronic social network. In some implementations, the computing device 102, 116 perform client-side operations, as discussed in further detail herein. In some implementations, the computing system 104 can include one or more computing devices such as a computer server. In some implementations, the computing system 104 can represent more than one computing device working together to perform the server-side operations, as discussed in further detail herein. In some implementations, the network 104 can be a public communication network (e.g., the Internet, cellular data network, dialup modems over a telephone network) or a private communications network (e.g., private LAN, leased lines).

In some implementations, the example system 100 can be used to book a travel accommodation on a travel conveyance 120. In some examples, the computing system 104 hosts a booking system that can be used to book a travel accommodation on the travel conveyance 120. For example, the user 108 can be a passenger and can access a booking interface provided on the computing device 102. In some implementations, the booking system can be a web-based system that provides a booking interface within a general purpose browser executed on the computing device 102. The user 108 can access information regarding the dates of travel and travel accommodations available on the travel conveyance and can generate a booking using the web-based system. In some examples, the user 118 can be an agent and can access a booking interface provided on the computing device 116. In some implementations, the booking system can be a web-based system that provides a booking interface within a general purpose browser or a booking-specific browser executed on the computing device 116. The user 118 can access information regarding a potential passenger, the dates of travel and travel accommodations available on the travel conveyance and can generate a booking using the web-based system. In some examples, the agent can be an independent agent (e.g., a travel agent). In some examples, the agent can be an employee of a travel service provider (e.g., an airline).

The travel associated with the booking can include a journey that can be made up of one or more segments. In some examples, the journey can include a single segment (e.g., a flight departing from a first airport and arriving at a second airport). In some examples, the journey can include multiple segments (e.g., a first flight departing from a first airport and arriving at a second airport, and a second flight departing the second airport and arriving at a third airport). Each booking can be associated with a passenger name record (PNR) that can include one or more passengers. In some examples, the booking includes a single passenger. In some examples, the booking includes multiple passengers. In accordance with implementations of the present disclosure, seat group eligibility is determined on a per passenger, per segment basis. In some implementations, the presence of multiple passengers on a single booking can influence the seat group eligibility of a particular passenger. In some implementations, the presence of multiple segments in a single journey can influence the seat group eligibility of a particular passenger.

In accordance with implementations of the present disclosure, booking data and profile data for a passenger, and operational data for a travel conveyance of a particular segment are processed to determine one or more seat groups that the passenger is eligible for. The booking data, the profile data and the operational data can be processed using a rules engine. The rules engine processes the data to determine seat group eligibility and provides a seat group eligibility index that includes a list of qualified seat groups per passenger, per segment. The index is provided as input to a seat assignment algorithm that can be provided in an equipment core engine to assign a particular seat to the passenger for each segment of travel.

In accordance with the present disclosure, the rules engine provides requirement identifiers, each requirement identifier corresponding to a seat group. In some examples, the rules engine enables “MustBe,” “MayBe,” and “MustNotBe” requirements to be specified for seat groups. In some examples, the MustBe requirement indicates that a seat assigned to a particular passenger must be selected from a particular seat group. In some examples, the MayBe requirement indicates that a seat assigned to a particular passenger can be selected from a particular seat group. In some examples, the MustNotBe requirement indicates that a seat assigned to a particular passenger cannot be selected from a particular seat group. Examples of the Mustbe, MustNotBe and MayBe requirements are discussed in further detail below. The MustBe, MustNotBe and MayBe requirements can be based on a particular rule condition such as the presence of a seat-dependent special service request (SSR) for a given passenger or for any other passenger on the same booking (e.g., in the case of multiple passengers on the same booking).

The booking data can include information that is specific to the booked journey and the one or more segments that make up the journey. As discussed in detail herein, the rules engine processes the booking data on a per segment, per passenger basis, although the booking data of one segment can influence the seat group eligibility of the particular passenger on another segment within the same journey, and the profile data of one passenger can influence the seat group eligibility of another passenger within the same booking. In some examples, the booking data can include data provided in Table 1 below, which is provided in the example context of a flight:

TABLE 1
Example Booking Data

| Booking Data | Description |
|---|---|
| FareBasis | The fare basis on the segment. |
| SegmentBookingClass | The fare class of service on the |
| | segment. |
| ProductClass | The product class of the fare on the |
| | segment. |
| OrganizationCode | The code identifying the |
| | organization that created the |
| | booking. |
| PromoCode | Promotion code, if any, used for |
| | the booking. |
| BookingChannel | Channel used to create the |
| | booking. |
| AnySSRCodeList* | SSRs booked on any passenger in |
| | the booking. |
| SSRCodeList* | SSRs booked on a given passenger |
| | in the booking. |
| FlightCarrier | Host carrier code of the segment. |
| FlightNumber | Flight number of the segment. |
| TravelDayofWeek | Departure day of week of flight |
| | segment. |
| DepartureStation | Departure station of the segment. |
| ArrivalStation | Arrival station of the segment. |
| JourneyDepartureStation | Departure station of first flight |
| | in the journey. |
| JourneyArrivalStation | Arrival station of last flight in |
| | the journey. |
| DaysBeforeDeparture | Total days before flight |
| | departure (Travel date in UTC − |
| | Current date in UTC). |
| HoursBeforeDeparture | Total hours before flight |
| | departure (Travel date in UTC − |
| | Current date in UTC). |
| MinutesBeforeDeparture | Total minutes before flight |
| | departure (Travel date in UTC − |
| | Current date in UTC). |
| IsSeatAssignmentSchedulerReseating | Indication as to whether seat |
| | assignment source is a Seat |
| | Assignment Scheduler. |
| Travel Date | Local departure date of the |
| | segment. |
| TravelTimeofDay | Local time of day that flight |
| | departs (24 hour time). |
| PassengerRecognitionValue* | A numerical value stored on a |
| | specific passenger and segment |
| | combination in the database, |
| | representing the results |
| | of a rules-based evaluation |
| | of passenger value. |
| PassengerAgeAtTravel* | Calculated age of the passenger at |
| | time of travel (in years). |
| Role | Role of agent requesting seat |
| | assignment or seat availability. |

A fare class can be provided as a sub-class of a travel class (discussed further below). Example travel classes can include first class, business class, premium economy class and economy class. One or more fare classes can be provided for each travel class. Example fare classes can include full-fare first class, first class, first class discounted and first class suites for the first class travel class. Example fare classes can include full-fare business class and business class discounted for the business class travel class. Example fare classes can include full-fare economy class, standard fare economy class and economy class discounted for the economy class travel class. The product class can be provided as a branding that a travel carrier imposes on a fare (e.g., frequent flyer fare, premium fare, etc.). The organization code booking data can correspond to an organization that generated the booking. An example organization can include a travel agency that booked the travel for the passenger. The station booking data corresponds to a location from which the travel conveyance departs and arrives (e.g., departing from a first airport and arriving at a second airport).

The promo code booking data can indicate a promotional code, if any, that was used in making the booking. The booking channel booking data indicates the particular channel used to generate the booking. Example booking channels can include a web-based booking channel (e.g., a booking generated through a website of the particular carrier, a booking generated through a website of a travel service), an agency-based booking channel (e.g., a booking generated using a travel agent), and a carrier-direct booking channel (e.g., a booking generated via telephone directly with the carrier). The any SSR code list booking data indicates any SSRs that are part of the booking, and can correspond to on any passenger in the booking (e.g., in the case of multiple passengers within the booking). The SSR code list indicates any SSRs booked for a particular passenger in the booking. The seat assignment rescheduler booking data indicates whether the seat assignment is being determined by a seat assignment scheduler, that can be executed as one or more computer program applications (e.g., on the computing system 104 of FIG. 1). The role booking data indicates a role of an agent that is requesting a seat assignment for a particular passenger on a particular segment. In some implementations, agents can use a role setting to override seat group eligibility for manual seat assignments based on the functionality discussed herein. In some examples, roles can include a system master that gives overall control of the reservation system, and an airline master role that authorizes most of a travel carrier's supervision controls on the reservation system.

The profile data can include information that is specific to a particular passenger of the booked journey. As discussed in detail herein, the rules engine processes the profile data on a per segment basis, although the profile data of another passenger within the same booking can influence the seat group eligibility of the particular passenger being considered. In some examples, the profile data can include data provided in Table 2 below:

TABLE 2
Example Profile Data

| Profile Data | Description |
|---|---|
| PassengerName | Passenger's legal name. |
| PassengerDOB | Passenger's date of birth. |
| AnyProgramCode | Customer program of any passenger in |
| | booking. |
| ProgramCode | Customer program of a particular |
| | passenger in booking. |
| AnyProgramLevelCode | Customer program and program level |
| | (status) of any passenger in booking. |
| ProgramLevelCode | Customer program and program level |
| | (status) of a particular passenger in |
| | booking. |
| AnySSRCodeList* | SSRs booked on any passenger in |
| | booking. |
| SSRCodeList* | SSRs booked on a particular passenger |
| | in booking. |
| PassengerRecognitionValue* | A numerical value stored on a specific |
| | passenger and segment combination in |
| | the database, representing the results of |
| | a rules-based evaluation of passenger |
| | value. |
| PassengerAgeAtTravel* | Calculated age of the passenger at time |
| | of travel (in years). |

In Tables 1 and 2, data marked with * indicates data that can be provided as booking data and/or profile data. The program code profile data can indicate a travel program that a passenger is a member of. Example travel programs can include frequent flyer programs, through which a passenger receives credit (e.g., mileage) for travel. Within a travel program, a member of the travel program can be of a particular level (e.g., platinum, gold, silver). The any program code profile data indicates a travel program that any passenger within the booking is a member of (i.e., in the case of a multiple passenger booking). The program code profile data indicates a travel program that a particular passenger within the booking is a member of. The any program level code indicates a level within the travel program of any passenger within the booking (i.e., in the case of a multiple passenger booking). The program level code profile data indicates a level within a travel program of a particular passenger within the booking.

The operational data can include information that is specific to a particular travel conveyance of a particular segment, and the mount of accommodations booked for the particular segment. As discussed in detail herein, the rules engine processes the operational data on a per segment basis. In some examples, the operational data can include data provided in Table 3 below:

TABLE 3
Example Operational Data

| Operational Data | Description |
|---|---|
| Equipment | Equipment type and suffix of the |
| | segment. |
| LoadFactor | The load factor for travel class on the |
| | segments. |

The equipment operational data specifies the particular travel conveyance for the particular segment (e.g., aircraft type). The load factor operational data specifies the percentage of accommodations booked for the particular segment per travel class. In some examples, travel class can include traditional notions of travel class, such as first class, business class, economy class, and the like. In some implementations, the load factor can be determined by looping through legs of the segment and retrieving inventory value data, finding the travel class that the class of service belongs to, determining the number of sold counts for all nests in the travel class, dividing the sum by the highest allowable inventory to be sold (lid count) for the travel class, multiply by 100 and return the lowest load factor among the legs in the segment.

In some examples, the rules engine enables one or more of the following: ability to select any SSR and use it to establish specific seat(s) and/or seat group eligibility, ability to identify and enforce seats and SSRs that have the defined characteristics, ability to mark an SSR as an “eligible to be automatically sent to a designated electronic queue (Queue Notify,” if the passenger has the SSR, but did not get a seat that matches the SSR, ability to select any SSR and denote that the SSR is required to allow seating in a specific seat in combination with an optional days or hours prior to scheduled flight departure, and in combination with an optional travel range exclusion, ability to set criteria (i.e., provided in the booking data, profile data and/or operational data) to determine seat and/or seat group eligibility, ability to create a set of rules for a seat assignment scheduler to use to seat unseated passenger (e.g., using variable pre-flight times), ability to set, at an SSR level, whether other passengers in the passenger name record (PNR) are able to inherit the eligibility to sit with other passengers in the PNR having the SSR, ability to provide no advance seat assignment eligibility notification, ability to identify specific agents and enable them to override and assign an otherwise restricted seat or seat group to a passenger, ability to apply the seat and/or seat group eligibility during all seat assignments (e.g., assign all (algorithmic), or select seat (manual)), and ability to set an infant capacity per seat set at the aircraft/equipment level. Each of these capabilities is discussed in further detail herein. In some examples, if a passenger has requested a particular SSR and the seat that the passenger is currently assigned to does not include the requested SSR, the passenger is added to a queue (“Queue Notify”) for the travel provider to address.

In general, a travel service provider (e.g., an airline) can define one or more seat group eligibility rules that are used to process the booking data, the profile data and the operational data for passengers and travel segments to determine seat group eligibility for a particular passenger on a particular segment. In some examples, an agent of the travel service provider can define the one or more seat group eligibility rules using a graphical user interface (GUI) provided on a computing device, the computing device executing and/or communicating with a remotely executed seat group eligibility application that provides a seat group eligibility rules engine. In some examples, the GUI can enable a user to add, edit and delete a seat eligibility rule. A rule name interface (e.g., dialog box) can be displayed, to which the user can enter a rule name (e.g., PAX With WCHR). The GUI can also display information about the rule including the date and time the rule was created, the user that created the rule, any date/time on which the rule was modified and the user that modified the rule.

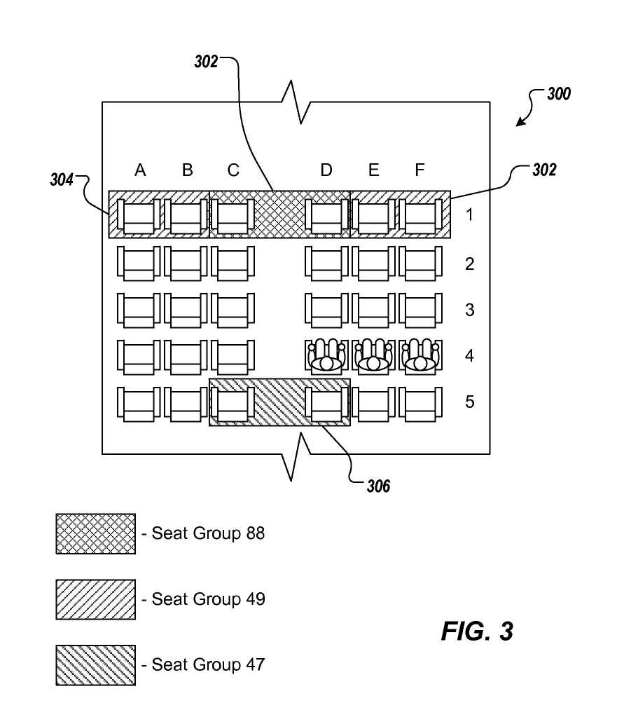

A rule conditions interface can be provided, into which the user can enter criteria, operators and values that define rule conditions. For purposes of illustration, example conditions can include the criteria “PassengerSSR,” the operator “Contains” and the value “Wheelchair (WCHR),” AND the criteria “AnyPassengerSSR,” the operator “Contains” and the value “Wheelchair (WCHR).” These example conditions are used below for purposes of illustration with reference to FIG. 3. Other example conditions are discussed throughout the present disclosure. A first actions interface can be provided and can receive user input to define what actions occur when the conditions provided in the conditions interface are met. The user can input one or more properties, one or more actions and one or more values into the first actions interface. Continuing with the example above, an example property “Seat Group—MustBe” can be associated with the example action “Add” and the example seat group value “88.” This action corresponds to a requirement that, if the condition PassengerSSR equals WCHR is met, the passenger must be seated in seat group 88. Another example property “Seat Group—MayBe” can be associated with the example action “Add” and the example seat group values 88, 49. This action corresponds to a requirement that, if the condition AnyPassengerSSR equals WCHR is met, the passenger may be seated in seat group 88 or seat group 49. A second actions interface can be provided and can receive user input to define what actions occur when the conditions provided in the conditions interface are not met. In some implementations, execution of other rules in associated rule sets can be halted, if a defined condition is met and corresponding actions are executed.

As discussed in further detail below, the seat group eligibility can be dynamically editable to provide flexibility in seat group eligibility. As one example, a rule can be defined to only provide a number of seats for seat assignments twenty-one (21) days or more before departure to passengers that purchased an economy fare. At six (6) weeks prior to departure, the travel service provider may realize that the particular flight is not selling well. Consequently, the rule can be modified to provide a larger number of seats for seat assignments to passengers that purchased the economy fare.

In some examples, a particular passenger might not be eligible for any seat groups on the travel conveyance at a given time. In some examples, a particular passenger might be eligible for a first set of seat groups at one time, and might be eligible for a second set of seat groups, different from the first set of seat groups, at another time. In this manner, seat group eligibility of the present disclosure is flexible. This flexibility can be achieved by editing the seat group eligibility rules and/or establishing seat group eligibility rules that include time-based criteria (e.g., economy fare passengers are not eligible for any seat groups 30 days or more before departure, and are eligible for specified seat groups less than 30 days before departure).

Implementations of the present disclosure enable the selection of any SSR and use of a selected SSR to establish specific seat(s) and/or seat group eligibility rules. This ensures that a travel service provider can use SSRs to allow assignment of seats to specific passengers who would otherwise not qualify to sit in a certain seat group. In this manner, a given seat group can be shielded from over exposure, while allowing targeted SSR-based passengers to override to the seat group. Further, the travel service provider can designate certain seats and/or seat groups as “MustBe” based on a particular SSR. For example, the presence of a wheelchair (WCHR) SSR could qualify a passenger to sit in seat group 50, even though the fare basis would normally only qualify the passenger to sit in seat group 20. In this example, the presence of the WCHR SSR could require the passenger to sit in an allowed WCHR seat that is in seat group 50. In some implementations, any SSR type (e.g., Baggage, Seat, Infant or Meal) can be designated. Other example SSRs that can be used to establish special seating eligibility can include a zone-based SSR (e.g., a seat within a zone that supports special services such as an exit row and/or extra leg room), an unaccompanied minor (UMNR) SSR (e.g., specifying specific rows reserved for unaccompanied minors), and a guide dog (GDOG) SSR (e.g., specifying that a passenger with a guide dog must sit in a particular row).

Implementations of the present disclosure enable the identification and enforcement of seats and SSRs that have defined characteristics. In this manner, a travel service provider can mark certain SSRs to drive passengers to be mandatorily required to sit in certain seats. An example characteristic can include a “must have” characteristic, such that a passenger must have a particular SSR in order to be eligible to sit in a particular seat group. As an example, in order to be eligible to sit in seat 1A, the passenger must have a GDOG SSR. Another example characteristic can include a “must” characteristic, such that the passenger must sit in a particular seat group if the SSR is present. As an example, a passenger having a GDOG SSR must sit in seat 1A, and, if the passenger is not seated in seat 1A, a seating fulfillment violation is triggered. Still another example characteristic can include a “may not” characteristic, such that a passenger may not be eligible for a particular seat group if a particular SSR is present. As an example, a passenger having an UMNR SSE cannot sit in an emergency exit row seat.

Implementations of the present disclosure enable an SSR to be marked as a “Queue Notify,” if the passenger has the SSR, but did not get a seat that matches the SSR. This enables seat assignments to still be performed even if the SSR cannot be fulfilled, while notifying the travel service provider via a queue to work with the unfulfilled passenger (e.g., to refund the passenger for an SSR that was paid for, but not received). In effect, this is a notification of a seat fulfillment violation, in that the passenger with the specific SSR did not get a seat that supports the specific SSR (i.e., a seat-dependent SSR). In some implementations, a seating queue can be provided to denote seats assigned to passengers with a “MustBe” criteria that are not met and that are not seat dependent (i.e., a seat-independent SSR). For example, the travel service provider can set up a rule that the presence of a GDOG SSR requires the passenger to sit in seat 1A. However, for some reason during a seating or reseating, seat 1A is not available for the passenger having the GDOG SSR, this passenger is assigned another and is queued for travel service provider intervention and handling. In some implementations, and to handle MustBe seat group violations, an overload for a “HoldSeats” method can be provided in a seat manager computer program application. The overload can contain a dictionary out parameter that can be used to return the list of MustBe seat group violations (e.g., by passenger number and list of applicable seat group(s)).

Implementations of the present disclosure enable the selection of any SSR and providing that the selected SSR is required to allow seating in a specific seat. In some implementations, this is in combination with an optional days or hours prior to scheduled flight departure, and/or in combination with an optional travel range exclusion. This enables the travel service provider to protect certain seats from pre-assignment, and to but also ‘release’ these seats at a specified time for other qualified passengers. As one example, the presence of a GDOG SSR would be required in order for a passenger to sit in seat 1A, if the scheduled departure of the flight is greater than 30 days from current date (i.e., the date on which the seat assignment is attempted). That is, the passenger cannot be assigned seat 1A greater than 30 days from departure, unless the passenger has a GDOG SSR). However, the presence of a GDOG SSR would not be required in order for a passenger, who qualifies otherwise, to sit in seat 1A, if the scheduled departure of the flight is less than 30 days from current date. That is, because the seat is being assigned in less than 30 days from departure, the GDOG SSR requirement no longer applies. As another example, the presence of a UMNR SSR would be required in order for a passenger to sit in row 30 (e.g., seats 30A/B/C/D/E/F) anytime. That is, the seats in row 30 are never be released for general assignment to passengers without a UMNR SSR.

In some examples, a requirement can be established based on a travel date range in combination with an SSR restriction. For example, seats in row 30 can be designated as being restricted to passengers with a UMNR SSR, except when the current date is less than 30 days from date of travel (i.e., scheduled departure). However, if the travel date is between 15 September to 30 September then the seats in row 30 are always restricted to passengers having a UMNR SSR, even if inside 30 days from flight departure. As another example, a seat group can be restricted to a particular SSR unless the current time is less than a threshold time before flight departure, except for a particular date range. For example, seat group 50 can be restricted to passengers that have a particular SSR (e.g., a zone-based SSR), unless the current time is less than 06 hours from scheduled flight departure. However, if the scheduled flight time is within a specified date range (e.g., 03MAR-30MAR), then seat group 50 remains restricted to passengers having the particular SSR, even if inside 06 hours from flight departure.

Implementations of the present disclosure enable criteria to be set to determine seat and/or seat group eligibility. Example criteria can include the booking data, profile data and/or operational data provided in one or more of Tables 1, 2 and 3 above.

Implementations of the present disclosure enable the creation of a set of rules for a seat assignment scheduler to use to seat unseated passenger (e.g., using variable pre-flight times). In this manner, operations staff of the travel service provider can begin to assign seats to selected passengers within a threshold time (e.g., X hours) prior to departure based on the presence or absence of certain criteria. As the departure time nears, more and more passengers are able to be assigned seats. In some examples, the criteria used can be provided as a sub-set of the requirements discussed above. For example, unseated passengers having specified SSRs can be assigned seats when the flight departure is less than 36 hours away, Gold members can be assigned seats when the flight departure is less than 24 hours away, Silver member can be assigned seats when the flight departure is less than 12 hours away, etc. In some examples, the eligibility for a seat to be assigned by operations staff can be different than the eligibility of the passenger to assign their own seat. For example, a Gold member may be allowed to have an advanced seat assignment up to 331 days in advance, yet a Gold member that does not have a seat assignment may not be assigned a seat by a seat assignment scheduler less than 36 hours prior to flight departure. In some examples, a travel program member that is not eligible for a seat group using a web-based tool may be eligible for the seat group if seated by the operations staff.

Implementations of the present disclosure enable setting, at an SSR level, whether other passengers in the PNR are able to inherit the eligibility to sit with other passengers in the PNR having the SSR. In this manner, PNR-associated travelers can be allowed or not allowed to be joined with the SSR-based passenger in the same booking, even though they would not normally qualify to sit in the specific seat or seat group. As one example, the presence of a GDOG SSR could be set to denote that it allows PNR inheritance for other passengers on the same booking. Consequently, a party of two, where only one passenger has the GDOG SSR, would be allowed to sit next to one another (e.g., the passenger with the GDOG SSR in seat 1A and the other passenger in the PNR in seat 1B. As another example, the presence of a zone-based SSR indicates that the particular passenger has paid to sit in an extra legroom/exit row seat, and the zone-based SSR can be set to denote that it does not allow inheritance for other passengers. Consequently, if only one passenger has a zone-based SSR in a party of two passenger, only the one passenger would be eligible for a seat group corresponding to the zone-based SSR. The other passenger could qualify for and be seated in a seat group based on their own seat and/or seat group eligibility.

In some implementations, SSR inheritance can apply whether the inheriting passenger is assigned their seat at the same time as the passenger having the SSR. For example, a PNR can include a party of two passengers, one passenger having WCHR SSR, and the other passenger not having a WCHR SSR. The passenger having the WCHR SSR can be assigned a seat (e.g., seat 1A). At some point later, the other passenger can still be assigned the seat adjacent to the seat assigned to the passenger with the WCHR SSR (e.g., seat 1 B), because the passenger is in the PNR with a WCHR passenger, and is still allowed to inherit the properties of the WCHR SSR.

Implementations of the present disclosure enable a no advance seat assignment eligibility notification to be provided. In this manner, it can be ensured that certain passengers are not allowed advanced seat assignments. This development should anticipate that certain passengers based on fares and time before departure will not be eligible for any seat or seat group. For example, a passenger that purchased a reduced-price fare will not be allowed to select an advance seat assignment until day of departure. In some implementations, an advanced seat assignment for this passenger could be made available for a fee.

Implementations of the present disclosure enable identification of specific agents and enable the agents to override and assign an otherwise restricted seat or seat group to a passenger. In this manner, select agents (e.g., a supervisor) can override and assign seats that would otherwise be hard restricted or ineligibility of seats to assignment. The designation of an agent as an override agent can be configured by role by the travel service provider. In some implementations, non-manual, algorithmic seat assignments do not use this override. As one example, a supervisor may need to assign a passenger to a zone-based SSR seat for VIP or customer service recovery reasons, even though there is not a zone-based SSR in the record. For example, a call center agent or airport agent may need to assign a passenger in one PNR to a seat in the WCHR row, because they are a travel companion of a passenger having a WCHR SSR in a separate PNR. In some implementations, the specific seat assignment can be requested by the override agent from a seat map or a seat availability listing.

Implementations of the present disclosure enable application of the seat and/or seat group eligibility during all seat assignments (e.g., assign all (algorithmic), or select seat (manual)). In this manner, eligible seats are consistently presented and are available no matter which channel is used or which seat command is used.

Implementations of the present disclosure enable an infant capacity per seat set to be specified at the aircraft/equipment level. In this manner, it can be ensured that infants are not seated in proximity to each other (e.g., due to the availability of extra oxygen masks). As one example, a travel service provider can allow two infants per three-seat unit set for a particular aircraft type. Consequently, when an infant request is made, the system identifies, for any seat that is designated as infant, whether more than two infants would end up in the unit set. If yes, the unit set is not part of the eligible seats for the operations staff to use. In some implementations, the most restrictive rule trumps during the evaluation of eligible SSR/rules for seats and/or seat groups. For example, if a rule is implemented such that a passenger with a BLND SSR may not access emergency row seats, but a VIP SSR is allowed access to emergency exit seats, the BLND SSR trumps.

In some examples, the rules engine processes booking data, passenger data and operational data based on one or more rules to generate a seat group eligibility index or a notification that the particular passenger is not currently eligible for any seats for a particular segment. As discussed herein, the seat group eligibility index includes one or more seat groups that a particular passenger is eligible to sit within and a plurality of requirement identifiers, each requirement identifier corresponding to a seat group. In some cases, a particular passenger may not be currently eligible for any seats for the particular segment.

In some implementations, the seat group eligibility index can be provided as a data object that can include a plurality of fields. In some examples, the fields can include a passenger number, a segment key, a list of MustBe seat groups, a list of MayBe seat groups and a list of MustNotBe seat groups. In some implementations, the passenger number is a unique identifier that is assigned to the particular passenger and the segment key is a unique identifier that is assigned to the particular segment. The seat groups can be identified by respective numbers. In some examples, a seat group number can range from 0 to 99. The seat groups that the particular passenger is eligible for on the particular segment can be provided as a list of seat groups identified by their respective numbers. For purposes of illustration, and example list of seat groups can include seat groups 40, 52, 60 and 80, indicating that the particular passenger is eligible to sit within a seat provided in one or seat groups 40, 52, 60 and 80.

The seat group eligibility index can be generated based on an initial seat group eligibility index. In particular, and in some implementations, filtering logic can be applied to the initial seat group eligibility index to generate the seat group eligibility index. The filtering logic can include one or more filtering rules. Example filtering rules can include:
Discard any “MayBe” seat groups in a list of seat groups that are greater than the highest “MustBe” seat group, if a “MustBe” seat group is in the list of seat groups.
Discard any “MayBe” seat groups in a list of seat groups that are equal to any “MustBe” seat group, if a “MustBe” seat group is in the list of seat groups.
Discard any “MayBe” or “MustBe” seat groups that are included in a “MustNotBe” seat group.

Examples seat group filtering is provided to illustrate application of the example filtering logic to an initial seat group eligibility index of example passengers. The example seat croup filtering is provided in Table 4 below:

| | Initial Seat | | |
|---|---|---|---|
| Pax | Groups | After Filtering | Reason for Change |
| Pax 1 | 70*, 60 | 70*, 60 | |
| Pax 2 | 70, 60, 50 | 70, 60, 50 | |
| Pax 3 | 70, 60* | 60* | MayBe > MustBe Removed |
| Pax 4 | | | |
| Pax 5 | 70* | 70* | |
| Pax 6 | 70*, 60, 50 | 70*, 60, 50 | |
| Pax 7 | 70 | 70 | |
| Pax 8 | 70, 60* | 60* | MayBe > MustBe Removed |
| Pax 9 | 70*, 60, 50** | 70*, 60 | MustNotBe 50 Removed |
| Pax 10 | 70*, 60, 70** | 60 | MustNotBe 70 Removed |
| Pax 11 | 70, 60*, 50 | 60*, 50 | MayBe > MustBe Removed |
| Pax 12 | 70 | 70 | |
| Pax 13 | 70, 60* | 60* | Maybe > MustBe Removed |
| Pax 14 | 70*, 60*, 50 | 70*, 60*, 50 | |
| Pax 15 | 70**, 60** | | MustNotBe 70 Removed |
| | | | MustNotBe 60 Removed |
| Pax 16 | 70, 60*, 60 | 60* | MayBe > MustBe Removed |
| | | | Duplicate MayBe Removed |

where PAX indicates a particular passenger,
*indicates a “MustBe” seat group,
**indicates a “MustNotBe” seat group and all other values are “MayBe” seat groups.

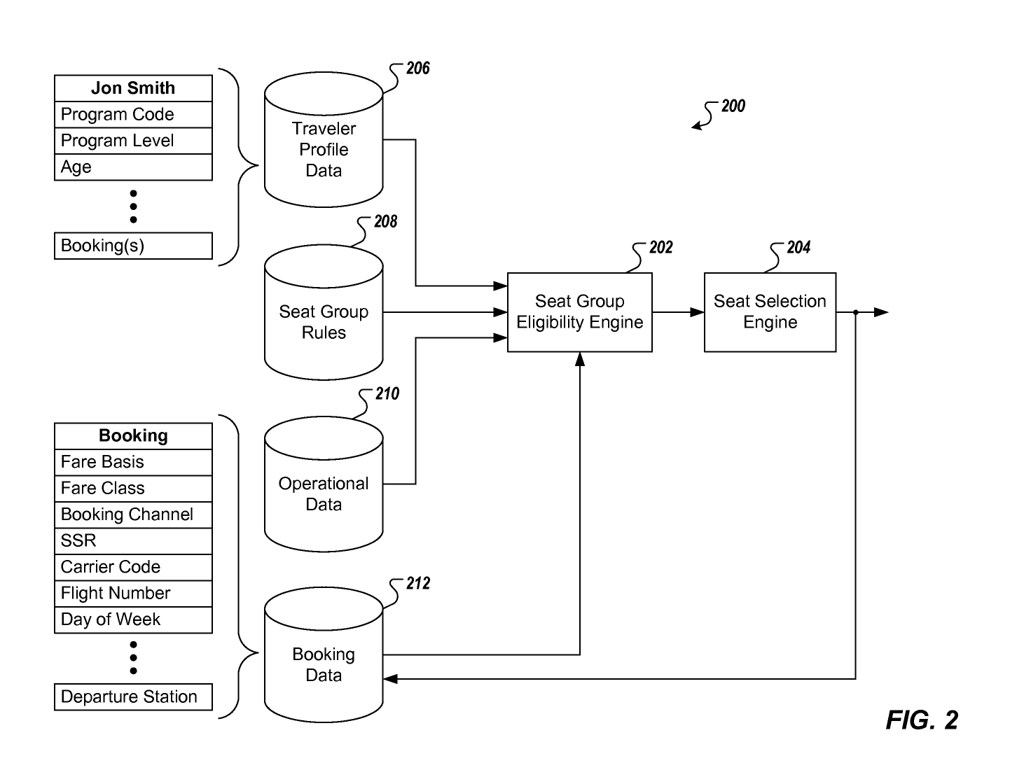

FIG. 2 depicts example components 200 that can be used to determine travel accommodation group eligibility. The example components 200 can include a seat group eligibility engine 202, a seat selection engine 204, a profile data database 206, a seat group rules database 208, an operational data database 210 and a booking data database 212. In some implementations, the seat group eligibility engine 202 and the seat selection engine 204 can each be provided as one or more computer program applications that can be executed by a computing device (e.g., computing device 110 of the computing system 104 of FIG. 1). In some implementations, each of the profile data database 206, the seat group rules database 208, the operational data database 210 and the booking data database 212 can be provided in one or more computer-readable storage devices (e.g., the computer-readable storage device 112 of the computing system 104 of FIG. 1).

The profile data database 206 stores data associated with one or more traveler profiles 220. Each travel profile 220 corresponds to a particular passenger and can include profile data. The profile data can include the example data provided in Table 2 and as discussed herein. The profile data 220 can also include a list of one or more bookings for travel that the particular passenger has booked. In this manner, the profile data 220 can be cross-referenced with appropriate booking data for the passenger. The seat group rules database 208 stores one or more rules used for determining seat group eligibility of passengers. As discussed above, the seat group rules can be generated, deleted and/or revised by a travel service provider to dynamically and flexibly define seat group eligibility for a particular passenger on a particular segment. The operational data database 210 stores operational data for a particular segment. In some examples, the appropriate operational data can be retrieved from the operational data database 210 by cross-reference to corresponding booking data. The booking data database 212 stores data associated with one or more bookings 222. Each booking 220 corresponds to a particular passenger and can include booking data. The booking data can include the example data provided in Table 1 and as discussed herein.

The seat group eligibility engine 202 can process booking data, profile data and operational data in view of one or more seat group rules to determine seat group eligibility of a particular passenger on a particular segment and to generate a corresponding seat group eligibility index. The seat selection engine 204 can receive the seat group eligibility index from the seat group eligibility engine 202. The seat selection engine 204 can process the seat group eligibility index to assign a seat to a particular passenger based on the seat groups that the passenger is eligible for. In some implementations, the seat selection engine 204 can assign a seat automatically. In some implementations, the seat selection engine 204 can receive user input (e.g., from an agent of a travel service provider) for manual selection of a seat. In some implementations, the user input can override seat group eligibility provided in the seat group eligibility index. The seat selection engine 204 can provide an indication as to the seat assigned to the particular passenger, which indication can be stored as booking data in the booking data database 204. In some implementations, the passenger may not be currently eligible for a seat assignment. In some examples, the seat group eligibility engine 202 generates a notification that a particular passenger is not eligible for any seat groups.

FIG. 3 depicts example seat map 300 including example travel accommodation groups. The example accommodation groups include a seat group 302 (seat group 88), a seat group 304 (seat group 49) and a seat group 306 (seat group 47). The example seat groups are used in an example seat group eligibility determination discussed in further detail below.

An example booking can include a plurality of passengers: Jon Smith, Mary Smith and Jim Smith (i.e., the passengers are associated with the same PNR for the booking). The passenger Jon Smith includes a WCHR SSR, the passenger Mary Smith has no SSR and the passenger Jim Smith includes a PET SSR (i.e., is traveling with a pet). Example seat eligibility rules can include:
If PassengerSSR=“WCHR”, SeatGroup=88, Requirement=MustBe
If AnyPassengerSSR=“WCHR”, SeatGroup=88, 49, Requirement=MayBe
If PassengerSSR=“PET”, SeatGroup=47, Requirement=MustBe

Referring again to FIG. 3, and continuing with the instant example, an example seat group setup can include seats 1C and 1D being in seat group 88 and being designated as WCHR seats, seats 1A, 1B, 1E and 1F being in seat group 49 and seats 5C and 5D being in seat group 47.

The booking data, profile data and operational data can be processed in view of the example rules to determine seat group eligibility for each of the passengers. In particular, it can be determined that the passenger Jon Smith must sit in seat group 88, because Jon Smith includes a WCHR SSR. It can be determined that Mary Smith may sit in seat group 49 or seat group 88, because, although Mary Smith has no SSR, Mary Smith is under the same PNR as Jon Smith. It can be determined that Jim Smith must sit in seat group 47, because although he could sit in seat group 49 or seat group 88, the PET SSR has a MustBe requirement that will trump any MayBe requirement.

A GUI can be provided for passenger seat selection. In some examples, the GUI can be presented to one or more of the passengers Jon Smith, Mary Smith and Jim Smith using a web-based check-in application or a check-in kiosk (e.g., a kiosk located within an airport terminal). In some examples, the GUI can be presented to an agent of the travel provider for selection of a seat assignment for each passenger. The GUI can present a list of passengers for a specified booking and the seat map 300. In this example, the list of passengers includes Jon Smith, Mary Smith and Jim Smith. The passenger Jon Smith can be selected from the list of passengers. In response to the selection of Jon Smith, the seat map 300 can display only seats 1C and 1D as being available for seat selection. Consequently, either seat 1C or seat 1D can be assigned to Jon Smith. In response to the selection of Mary Smith, the seat map 300 can display seats 1A to 1F (i.e., any seat in row 1) as being available for seat selection. Consequently, any of seats 1A to 1F can be assigned to Mary Smith. In response to the selection of Jim Smith, the seat map 300 can display seats 5C and 5D as being available for seat selection. Consequently, either seat 5C or seat 5D can be assigned to Jim Smith.

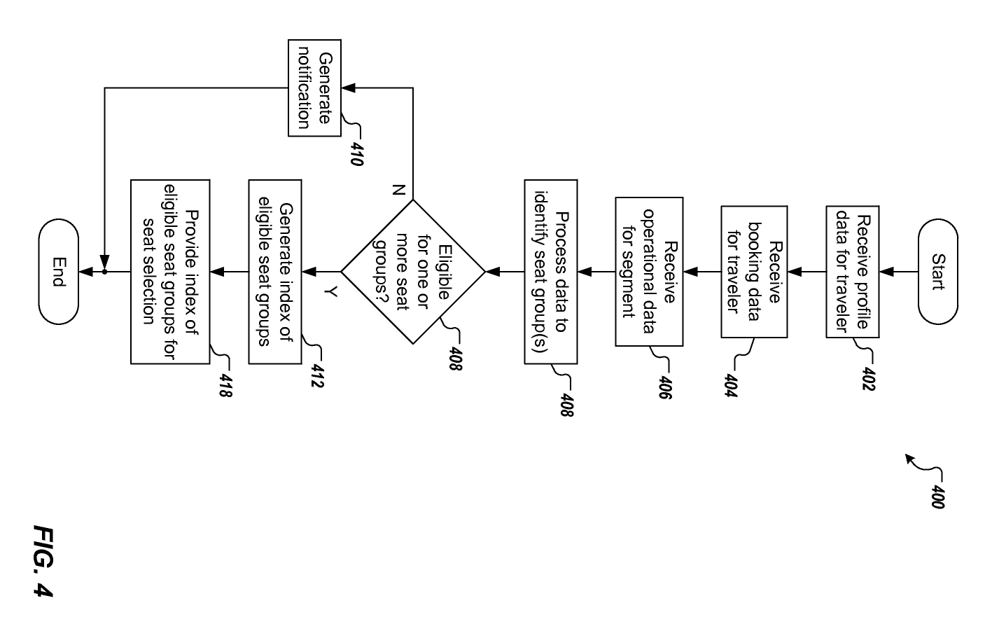

FIG. 4 is a flowchart of an example process 400 that can be executed in accordance with implementations of the present disclosure. In some examples, the process 400 can be implemented using one or more computer program applications executed using one or more computing devices.

Profile data for a traveler is received (402). Booking data for the traveler is received (404). The booking data can correspond to a travel segment booked by the traveler. Operational data for the segment is received (406). The operational data can correspond to a travel conveyance (e.g., aircraft) used for the segment. The profile data, booking data and operational data are processed (408) to identify one or more seat groups that the particular passenger may be eligible for on the particular segment. As discussed above, the data is processed based on one or more seat group eligibility rules that can include conditions and actions when conditions are met and/or actions when conditions are not met.

It is determined whether the passenger is eligible for one or more seat groups (408). In some examples, the passenger may not be eligible for a seat group at a given time, but may be eligible for a seat group at another time. If it is determined that the passenger is not currently eligible for one or more seat groups a notification is generated (410) and the example process 400 ends. In some examples, the notification can be displayed to the passenger in response to the passenger's attempt to select a seat (e.g., a seat map is displayed and indicates that no seats are available). In some examples, the notification can be displayed to an agent of a travel service provider. If it is determined that the passenger is eligible for one or more seat groups, an index of eligible seat groups for the passenger is generated (412) and can be stored in computer-readable memory. The index of eligible seat groups is provided for seat selection (418) and the example process ends. In some examples, the index of eligible seat groups can be provided to a seat selection engine that can automatically assign a seat to the passenger from one of the seat groups or can receive manual user input to assign a seat to the passenger. In some examples, a seat map can be presented (e.g., to the passenger or an agent) and the seat map can indicate one or more seats that are available to the passenger for assignment based on the one or more seat groups.

Implementations of the present disclosure can be used to realize one or more of the following advantages. SSRs (e.g., unaccompanied minors, wheelchair, guide dog, etc.) information can be used to force a seat on the travel conveyance to match travel provider policies based on configurable rules. These restricted seats can be made available for general assignment at a certain point in time prior to departure. Implementations provide the ability to recognize valuable customers based on who the passenger is and/or what the passenger purchased. This information can be used to determine whether advanced seat assignments should be offered. If advanced seat assignments are offered, more desirable seats can be made available to these customers based on configuration. These seats can be made available for general assignment at a certain point in time prior to departure. Implementations provide the ability to control customer access to seat selection during the booking process and/or the check-in process. The eligibility of the seats that can be selected is determined dynamically and allows the customer be more self-sufficient while enabling the travel provider to enforce their own specific seat assignment preferences.

Generally, implementations of the present disclosure provide optimization of assignment of units (e.g., seats on a travel conveyance) based on a combination of carrier operational, passenger valuation, and point in time circumstances. In particular, a seat can be assigned to a passenger based on multiple criteria, including traveling companions, market conditions, load factors and the like. Implementations avoid overt violations of seating requirements (e.g., 2 wheelchairs cannot fit in a single area of the aircraft), avoid hidden violations of seating requirements (e.g., a premium or elite passenger is seated in a seat designated as ‘poor seating’ on an aircraft), and avoid flight delays and agent labor costs by proactively seating each passenger in each seat according to the rules, avoiding manual re-seating.

Implementations of the present disclosure and all of the functional operations provided herein can be realized in digital electronic circuitry, or in computer software, firmware, or hardware, including the structures disclosed in this specification and their structural equivalents, or in combinations of one or more of them. Implementations of the present disclosure can be realized as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclose can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the present disclosure can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this disclosure includes some specifics, these should not be construed as limitations on the scope of the disclosure or of what may be claimed, but rather as descriptions of features of example implementations of the disclosure. Certain features that are described in this disclosure in the context of separate implementations can also be provided in combination in a single implementation. Conversely, various features that are described in the context of a single implementation can also be provided in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the present disclosure have been described. Other implementations are within the scope of the following claims. For example, the actions recited in the claims can be performed in a different order and still achieve desirable results. A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for selecting a unit for a customer, comprising:
receiving booking data for one or more customers, the booking data being stored in one or more computer-readable storage media;
receiving profile data for each of the one or more customers, the profile data being stored in one or more computer-readable storage media;
receiving operational data, the operational data being stored in one or more computer-readable storage media;
processing the booking data, the profile data and the operational data based on one or more unit eligibility rules, each unit eligibility rule of the one or more unit eligibility rules comprising one or more conditions and one or more actions associated with the one or more conditions;
generating an eligible unit group index based in the processing; and
providing the eligible unit group index as input to a unit selection engine.

2. The method of claim 1, wherein the eligible unit group index comprises the one or more customers and, for each customer of the one or more customers, a list of one or more unit groups that each customer of the one or more customers is eligible for.

3. The method of claim 1, wherein:
the eligible unit group index is generated at a first time and comprises the one or more customers and, for at least one customer of the one or more customers, an empty list of unit groups that the at least one customer is eligible for, the empty list indicating that the at least one customer is ineligible for assignment of a unit at the first time; and
the eligible unit group index is re-generated at a second time and, for the at least one customer, comprises a list of one or more unit groups that the at least one customer is eligible for at the second time.

4. The method of claim 1, wherein the unit comprises one of a seat and a room in a travel conveyance, and the customer comprises a passenger on the travel conveyance.

5. The method of claim 4, wherein the travel conveyance corresponds to a segment of a journey and the operational data corresponds to the segment.

6. The method of claim 5, wherein the operational data comprises an equipment type associated with the travel conveyance and a load factor associated with the segment.

7. The method of claim 4, wherein the booking data comprises one or more of a fare basis, a booking class, a product class, an organization code, a promotional code, a booking channel, a list of special service requests (SSRs) in a passenger name record (PNR), an SSR associated with a booking of a particular passenger, a day of week of travel, a segment departure station, a segment arrival station, a journey departure station, a journey arrival station, a number of days before departure, a number of hours before departure, a number of minutes before departure, a travel date, a travel time of day, and a passenger age at travel.

8. The method of claim 4, wherein the booking data comprises a role corresponding to an agent that is assigning the unit to a customer.

9. The method of claim 8, wherein the role overrides one or more unit eligibility rules in assigning the unit to a customer.

10. The method of claim 4, wherein the profile data comprises at least one of passenger date of birth data, a program code of at least one passenger, a program level of at least passenger, a list of special service requests (SSRs) in a passenger name record (PNR), and an SSR associated with a particular passenger.

11. The method of claim 4, wherein the travel conveyance comprises one or an airplane, a train, a bus and a ship.

12. The method of claim 4, wherein the generating the eligible unit group index is based on a current date relative to a departure date.

13. The method of claim 4, wherein the generating the eligible unit group index is based on a current time relative to a departure time.

14. The method of claim 1, further comprising receiving user input, the user input defining the one or more unit eligibility rules.

15. The method of claim 14, wherein the user input is provided by an agent of an entity that provides the one or more units.

16. The method of claim 1, further comprising receiving user input, the user input modifying a unit eligibility rule of the one or more unit eligibility rules.

17. The method of claim 16, wherein the user input is provided by an agent of an entity that provides the one or more units.

18. The method of claim 1, wherein the eligible unit group index comprises the one or more customers and, for each customer of the one or more customers, a list of one or more unit groups that each customer of the one or more customers is eligible for and one or more requirement identifiers, each requirement identifier being associated with each unit group of the one or more unit groups.

19. The method of claim 18, wherein each requirement identifier comprises at least one of a must be identifier, a may be identifier and a may not be identifier.

20. The method of claim 19, wherein the must be identifier indicates a unit group from which a unit must be assigned to a particular customer.

21. The method of claim 19, wherein the may be identifier indicates a unit group from which a unit is able to be assigned to a particular customer.

22. The method of claim 19, wherein the must not be identifier indicates a unit group from which a unit cannot be assigned to a particular customer.

23. A system comprising:
one or more computers; and
a computer-readable medium coupled to the one or more computers having instructions stored thereon which, when executed by the one or more computers, cause the one or more computers to perform operations comprising:
receiving booking data for one or more customers, the booking data being stored in one or more computer-readable storage media;
receiving profile data for each of the one or more customers, the profile data being stored in one or more computer-readable storage media;
receiving operational data, the operational data being stored in one or more computer-readable storage media;
processing the booking data, the profile data and the operational data based on one or more unit eligibility rules, each unit eligibility rule of the one or more unit eligibility rules comprising one or more conditions and one or more actions associated with the one or more conditions;
generating an eligible unit group index based in the processing; and
providing the eligible unit group index as input to a unit selection engine.

24. A computer storage medium encoded with a computer program, the program comprising instructions that when executed by one or more computers cause the one or more computers to perform operations comprising:
receiving booking data for one or more customers, the booking data being stored in one or more computer-readable storage media;
receiving profile data for each of the one or more customers, the profile data being stored in one or more computer-readable storage media;
receiving operational data, the operational data being stored in one or more computer-readable storage media;
processing the booking data, the profile data and the operational data based on one or more unit eligibility rules, each unit eligibility rule of the one or more unit eligibility rules comprising one or more conditions and one or more actions associated with the one or more conditions;
generating an eligible unit group index based in the processing; and
providing the eligible unit group index as input to a unit selection engine.
